(19) United States
(12) Patent Application Publication
(10) Pub. No.: US 2021/0184760 A1
(43) Pub. Date: Jun. 17, 2021

(54) MULTI-MODE COMMUNICATION SYSTEM WITH SATELLITE SUPPORT MECHANISM AND METHOD OF OPERATION THEREOF

(71) Applicant: Mosat Corporation, Fort Lee, NJ (US)

(72) Inventor: Syngbum Kim, Fort Lee, NJ (US)

(21) Appl. No.: 16/713,729

(22) Filed: Dec. 13, 2019

(51) Int. Cl. H04B 7/185; H01Q 21/06; H01Q 21/30; H01Q 13/02; H01P 1/213; H01Q 1/24; H01Q 1/28; H01Q 5/55; H01Q 9/04; H04B 7/19; H04B 7/195

(52) U.S. Cl. CPC H04B 7/18513; H01Q 21/065; H01Q 21/30; H01Q 13/025; H01P 1/2138; H04B 7/195; H01Q 1/288; H01Q 5/55; H01Q 9/0457; H04B 7/19; H01Q 1/247

(57) ABSTRACT

A multi-mode communication system includes: a flat panel antenna configured to couple a satellite receive a down-link satellite packet; a satellite Rx/Tx, coupled to flat panel antenna, configured to decode the down-link satellite packet; a storage device, coupled to the satellite Rx/Tx, configured to store satellite data from down-link satellite packet; an interface module configured to encode and transfer satellite data as cellular communication packets, WiFi packets, location and services packets, when a local infrastructure is disabled; wherein: interface module further configured to receive cellular communication packets, WiFi packets, location/services packets, and store in satellite data; the satellite Rx/Tx further configured to encode the satellite data up-link satellite packet; and the flat panel antenna further configured to transmit up-link satellite packet to the satellite.

### TECHNICAL FIELD

An embodiment of the present invention relates generally to a multi-mode communication system, and more particularly to a communication system for reduced power operations while under emergency conditions.

### BACKGROUND

Modern satellite communication systems rely on costly, high maintenance, and immobile ground-based stations. The ground-based stations can provide high bandwidth access to satellites in Geosynchronous Earth orbit (GEO) or low Earth orbit (LOE). Unfortunately, these ground-based stations are susceptible to natural disasters and power outages. These resources can be taken away by weather phenomena, such as tornadoes, hurricanes, flooding, or just a loss of power to a stricken area. As first responders attempt to respond to any natural disaster, they desperately need communication services that have been disabled by the disaster the first responders are addressing.

Thus, a need still remains for a multi-mode communication system with satellite support mechanism to provide improved performance, data reliability and recovery. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides an apparatus, including a multi-mode communication system, including: a flat panel antenna configured to couple a satellite including receiving a down-link satellite packet; a satellite Rx/Tx, coupled to the flat panel antenna, configured to decode the down-link satellite packet; a storage device, coupled to the satellite Rx/Tx, configured to store satellite data from the down-link satellite packet; an interface module, coupled to the storage device, configured to encode and transfer the satellite data as cellular communication packets, WiFi packets, location and services packets, or a combination thereof when a local infrastructure is disabled; and wherein: the interface module is further configured to receive the cellular communication packets, the WiFi packets, the location and services packets, or a combination thereof and store the content in the satellite data; the satellite Rx/Tx is further configured to encode the satellite data as an up-link satellite packet; and the flat panel antenna is further configured to transmit the up-link satellite packet to the satellite.

An embodiment of the present invention provides a method including: coupling a flat panel antenna to a satellite including receiving a down-link satellite packet; decoding the down-link satellite packet including storing the satellite data; encoding the satellite data to form cellular communication packets, WiFi packets, location and services packets, or a combination thereof; transmitting the cellular communication packets, the WiFi packets, and the location and services packets, when the local infrastructure is disabled; storing the cellular communication packets, WiFi packets, location and services packets in the satellite data; encoding an up-link satellite packet from the satellite data; and transmitting the up-link satellite packet through the flat panel antenna to the satellite.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a functional block diagram of a multi-mode communication system with satellite support mechanism in an embodiment of the present invention.

FIG. 2 is an exploded view of a flat panel antenna in an embodiment.

FIG. 3 is an assembly drawing of a segment of the feedhorn array of FIG. 2 in an embodiment of the present invention.

FIG. 4 is a functional block diagram of the transportable base station in an alternative embodiment of the present invention.

FIG. 5 is a flow chart of a method of operation of a multi-mode communication system in an embodiment of the present invention.

### DETAILED DESCRIPTION

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the present invention.

In the following description, numerous specific details are given to provide a thorough understanding of the invention. However, it will be apparent that the invention may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation.

As an example, objects in low-Earth orbit are at an altitude of between 160 to 2,000 km (99 to 1200 mi) above the Earth's surface. Any object below this altitude will suffer from orbital decay and will rapidly descend into the atmosphere, either burning up or crashing on the surface. Objects at this altitude also have an orbital period (i.e. the time it will take them to orbit the Earth once) of between 88 and 127 minutes. A geosynchronous orbit is a high Earth orbit that allows satellites to match Earth's rotation. Located at 22,236 miles (35,786 kilometers) above Earth's equator, this position is a valuable spot for monitoring weather, communications and surveillance.

As an example, three parameters can be manipulated in order to optimize the capacity of a communications link—bandwidth, signal power and channel noise. An increase in the transmit power level results in an increase of the communication link throughput, likewise a decrease in power will result in the opposite effect reducing the throughput. Also for example, another way to improve the link throughput would be to increase the size of the receiving antenna in order to have a higher level of energy received at an aircraft. But this is where operational constraints become apparent, as, this would lead to an unfeasible installation for a commercial or business aircraft.

The term “module” referred to herein can include specialized hardware supported by software in an embodiment of the present invention in accordance with the context in which the term is used. For example, the software can be machine code, firmware, embedded code, and application software. Also, for example, the specialized hardware can be circuitry, processor, computer, integrated circuit, integrated circuit cores, a pressure sensor, an inertial sensor, a microelectromechanical system (MEMS), passive devices, or a combination thereof. The term “abut” referred to herein is defined as two components in direct contact with each other with no intervening elements. The term “couple” referred to herein is defined as multiple objects linked together by wired or wireless means.

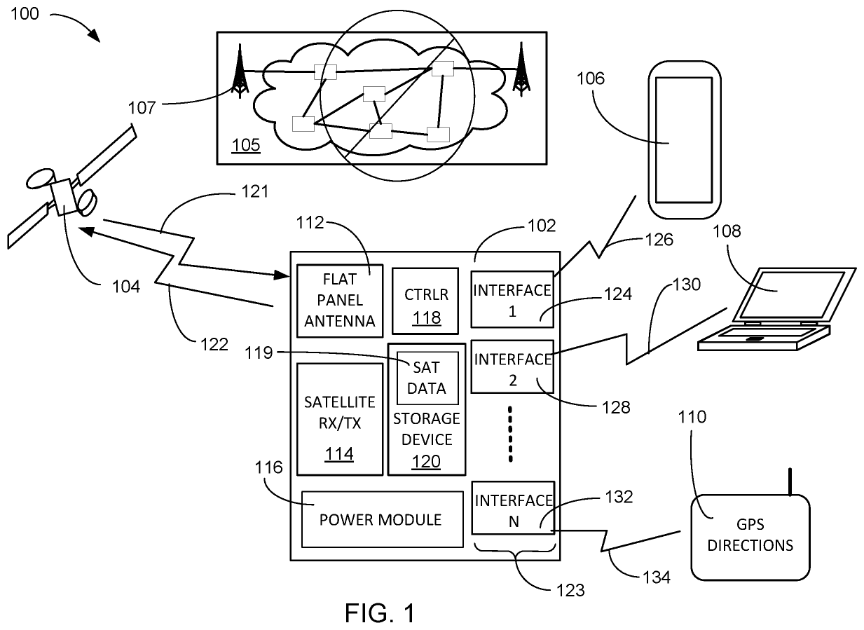

Referring now to FIG. 1, therein is shown a functional block diagram of a multi-mode communication system 100 with satellite support mechanism in an embodiment of the present invention. The multi-mode communication system 100 is depicted in FIG. 1 as a functional block diagram of the multi-mode communication system 100 with a transportable base station 102.

The transportable base station 102 can be a self-contained hardware structure that can couple to a satellite 104 in order to provide communication in a region where the local infrastructure 105 is disabled due to damage or loss of power. The transportable base station 102 can be customized to provide support for the satellite 104 in low-Earth orbit (LEO), at an altitude of between 160 to 2,000 km (99 to 1200 mi) above the Earth's surface, or geosynchronous Earth orbit (GEO), which is a high Earth orbit located at 22,236 miles (35,786 kilometers) above Earth's equator, that allows satellites to match Earth's rotation. The satellite 104 can transmit and receive a Ka band signal in the range of 17.8 to 18.6 GHz or 27.5 to 28.35 GHz. It is understood that the transportable base station 102 can be configured to support other orbit altitudes and frequency spectrums without limiting the invention.

The transportable base station 102 can provide a communication link between the satellite 104 and cellular application 106, including cell phones supporting third generation telecommunication (3G), long term evolution (LTE), fourth generation telecommunication (4G), fifth generation telecommunication (5G), or a combination thereof. The transportable base station 102 can also provide a communication link between the satellite 104 and a wireless fidelity application (WiFi) 108. The WiFi application 108 can include computers, laptops, tablets that access a local area network (LAN), a wide area network (WAN), a Fiber-Channel token ring (FC), or a combination thereof. The transportable base station 102 can also provide a communication link between one or more of the satellite 104 and a global positioning system application (GPS) 110.

By way of an example, in a disaster situation, the transportable base station 102 can provide basic and advanced communication services for first responders attempting to restore power and assist residence in a devastated region. The transportable base station 102 can be configured to support other interface structures (not shown), including Bluetooth, Near Field communication, laser communication, or the like.

The transportable base station 102 can include a flat panel antenna 112 coupled to a satellite receiver/transmitter (Rx/Tx) 114 configured to communicate with the satellite 104 orbiting the Earth in the LEO or the GEO position. The flat panel antenna 112 can be configured to support frequencies in a Ku frequency band, in the range of 13.4 GHz through 14.9 GHz, in a Ka frequency band, in the range of 27.5 GHz through 32.5 GHz, in a 5G frequency band, targeted for 15 GHz or 28 GHz, or a combination thereof. It is understood that other frequency ranges can be supported in both higher frequency and lower frequencies. The flat panel antenna 112 can be a feed horn array coupled to a waveguide interposer and a waveguide interface for communicating with the satellite Rx/Tx 114.

A power module 116 can provide independent power required to operate the transportable base station 102. The power module 116 can include batteries, solar power, a generator interface, wind mill power, or a combination thereof. The power module 116 can include any sustainable power source that will provide sufficient energy to enable the communication through the transportable base station 102.

The transportable base station 102 can also include a station controller 118, such as a processor, a micro-computer, a micro-processor core, an application specific integrated circuit (ASIC) an embedded processor, a microprocessor, a hardware control logic, a hardware finite state machine (FSM), a digital signal processor (DSP), or a combination thereof. The station controller 118 can manage the operations of the transportable base station 102 including managing a satellite data 119. The satellite data 119 can be the payload from down-link satellite packets 121 or the preparation data for encoding up-link satellite packets 122. The station controller 118 can access a storage device 120 that can provide a data storage function for receiving and reformatting the down-link satellite packets 121 of the satellite data 119 for transfer to the cellular application 106, the WiFi application 108, the global positioning system application (GPS) 110, or a combination thereof. The station controller 118 can access a storage device 120 that can provide a data storage function for assembling the satellite data 119 requests from the cellular application 106, the WiFi application 108, the global positioning system application (GPS) 110, or a combination thereof that can be submitted to the Satellite Rx/Tx 114 to generate the up-link satellite packets 122.

The storage device 120 can include a hard disk drive (HDD), a solid-state storage device (SSD), non-volatile memory, volatile memory, or a combination thereof. The physical capacity of the storage device 120 can be configured based on the number and type of interface modules 123 that are to be activated by the transportable base station 102.

By way of an example, the transportable base station 102 can be configured with a first interface module 124 that can provide cellular communication packets 126 to the cellular application 106, a second interface module 128 that can provide WiFi packets 130 for the WiFi application 108, and an Nth interface 132 that can provide location and services packets 134 to the GPS application 110. It is understood that other types of the interface modules 123 can be installed in the transportable base station 102 in order to address the communication needs of a region (not shown) that has the local infrastructure 105 disabled due to damage or loss of power.

It is understood that the transportable base station 102 can provide needed satellite communication options, when the local infrastructure 105 cannot support the communication requirement for the region. This could be caused by natural disaster, man-made or naturally occurring power loss, damage to cell towers 107, or communication traffic overload due to some calamity. The transportable base station 102 can provide a configurable communication interface for mobile applications, including police and fire department vehicles, military, commercial, and private water vessels, military, commercial, or private aircraft.

The transportable base station 102 can provide multiple communication types in an off-the-grid environment. Many remote locations rely on the satellite 104 for basic communication and Internet services. The transportable base station 102 can be installed in a mobile device (not shown) including an automobile, a train, a motorcycle, an airplane, a boat, a bicycle, or the like. The multi-mode communication system 100 of the present invention can quickly provide a communication infrastructure in regions where the local infrastructure 105 is disabled due to lack of power or natural disasters have disabled any of the local infrastructure 105 that may have been present.

It has been discovered that the multi-mode communication system 100 can quickly provide the cellular packets 126 for the cellular application 106, the WiFi packets 130 for the WiFi application 108, the location and services packets 134 to the GPS application 110, or a combination thereof when the local infrastructure 105 is disabled or missing completely. Since the transportable base station 102 can be configured for communicating with specific ones of the satellite 104 and provide multiple of the interface modules 123 to address communication issues that previously required a base station the size of a house that cannot be transported or quickly configured to address outages that can befall a region.

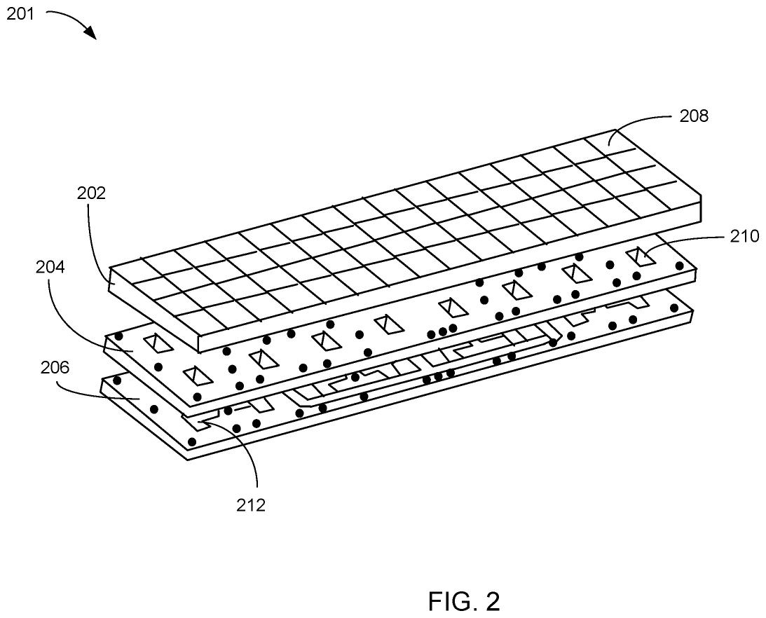

Referring now to FIG. 2, therein is shown an exploded view of a flat panel antenna 201 in an embodiment. The flat panel antenna 201 can include a feed horn array 202, a waveguide interposer 204 and a waveguide interface board 206 that can direct the frequencies of the down-link satellite packets 121 of FIG. 1 to the satellite Rx/Tx 114 of FIG. 1. By way of an example, the feed horn array 202 is shown having a four by 16 configuration. Each of the feed horns 208 can be configured to operate with three of the adjacent ones of the feed horn 208 to steer the down-link satellite packets 121 into the waveguide interposer 204. The feed horn array 202 can have dimensions of 12.5 cm×2.15 cm (4.92″×0.85″). The embodiment of the flat panel array 201 is suitable for communication with the satellite 104 of FIG. 1 in a low-Earth orbit (LEO) and using a Ka frequency spectrum in the range of 17.8 to 18.6 GHz or 27.5 to 28.35 GHz.

The waveguide interposer 204 can abut the feed horn array 202. A tight seal between the waveguide interposer 204 and the feed horn array 202 can provide a low impedance path for the down-link satellite packets 121 at a received frequency in the Ka band specified as a frequency range of 27.5 GHz to 32.5 GHz as a down-link. In a further embodiment the flat panel antenna 201 can also transmit the up-link satellite packets 122 and receive the down-link satellite packets 121 at a frequency range of 11.075 GHz to 14.375 GHz to and from the satellite 104 that is in a geosynchronous Earth orbit (GEO). In this example, the flat panel antenna 201 used to support the satellite 104 operating in GEO has a dimension of 30 cm×30 cm (11.81″ by 11.81″) and is configured as a 32 by 32 array of the feed horn 208.

The waveguide interposer 204 can have a waveguide opening 210 that is specific to the frequency used to communicate with the satellite 104. The waveguide opening 210 for the satellite 104 configured in LEO can have a dimension of 19.05 mm by 9.525 mm of the rectangular shape of the waveguide openings 210. The waveguide opening is oriented so that four of the feed horns 208 are aligned with the input of the waveguide opening 210. This also allows the flat panel antenna 201 to use electronic tracking of the satellite 104.

The waveguide interface board 206 can abut the waveguide interposer 204, opposite the feed horn array 202. The waveguide interface 206 can have a rectangular waveguide 212 formed on the surface that abuts the waveguide interposer 204. the openings of the rectangular waveguide 212 are aligned with the waveguide openings 210 of the waveguide interposer 204, forming an impedance matched structure that can pass the down-link satellite packets 121 with a gain of 20.0 to 23.8 dBi for the LEO configuration and a gain of 36.3 to 36.8 dBi for the larger of the flat panel antenna 201 in the GEO configuration.

It has been discovered that multi-layer structure of the flat panel antenna 201 can improve gain the antenna structure is assembled by joining the feed horn array 202, the waveguide interposer 204, and the waveguide interface board 206. By matching the impedance of the combined structure, the flat panel antenna 201 can boost the overall gain of the flat panel antenna 201 by 1 to 3 dB. In addition, the voltage standing wave ratio (VSWR) of the antenna is less than 2:1, and the return loss is also lower than −10 dB. Because the structure requires the up-link satellite packet 122 and the down-link satellite packets 121 to make a 90-degree turn between the waveguide interposer 204 and the waveguide interface board 206, a bulge structure was added to the waveguide interface board 206 to reduce the reactance of the circuit and optimized the transmission of the up-link satellite packet 122 and the down-link satellite packets 121.

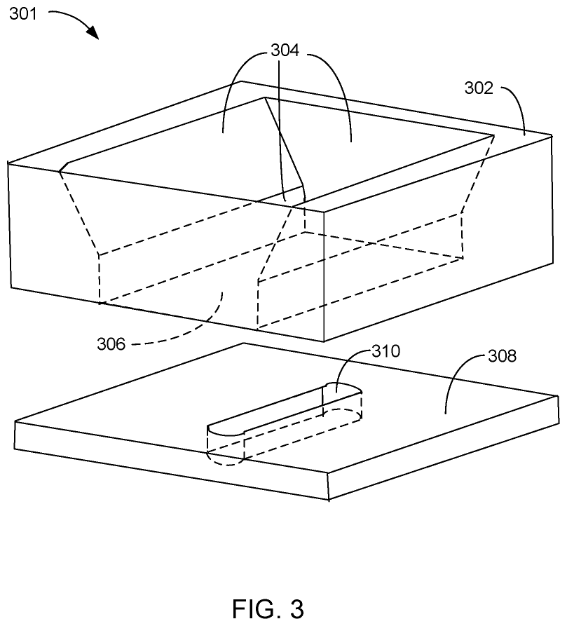

Referring now to FIG. 3, therein is shown an assembly drawing of a segment 301 of the feedhorn array 202 of FIG. 2 in an embodiment of the present invention. The assembly drawing of the segment 301 depicts a feed horn layer 302 can be formed in the shape of a square approximately 8.5 mm on a side and a depth of approximately 2.5 mm. The feed horn layer 302 can be formed of a plastic including Acrylonitrile Butadiene Styrene (ABS), polypropylene (PP), polyether-ether-ketone (PEEK), or the like. An active surface 304 can be plated with Nickel (Ni) in order to direct the frequencies of the down-link satellite packets 121 of FIG. 1 into an opening 306.

A slot layer 308 can be formed to fit on the feed horn layer 302. A slot opening 310 can be cut through the slot layer 308 the sides of the slot opening 310 and the surface of the slot layer can be coated with Nickel (Ni) in order to direct the frequencies from the feed horn layer 302 through the slot opening 310. The position of the slot opening 310 can be set to allow up to four of the segments 301 to be directed into a single one of the waveguide openings 210 of FIG. 2 on the waveguide interposer 204 of FIG. 2.

The size of the slot opening 310 is an important aspect of the operation of the transportable base station 102 of FIG. 1. In order to calculate the correct size of the slot opening 310 for the target frequencies the design is subject to the following equations:

$$W = \frac{1}{2 {f}_{r} \sqrt{{μ}_{0} {ɛ}_{0}}} \sqrt{\frac{2}{{ɛ}_{r} + 1}} = \frac{{v}_{0}}{2 {f}_{r}} \sqrt{\frac{2}{{ɛ}_{r} + 1}} \qquad ( EQ 1 )$$

Where ε0 is the permuttivity of free space, μ0, is the permeability of free space, which is exactly 4π×10−7 W/A·m, by definition. W is the width of the slot opening 310, fr is the resonant frequency of the waveguide interposer 204 of FIG. 2 that the slot opening 310 is to be coupled. In order to receive the geostationary frequency band, the slot length and width length must be determined. When the horizontal length is W and the vertical length is L, the design parameters of the slots can be expressed by permittivity (εr), resonance frequency (fr), and substrate thickness (h).

$$L = \frac{1}{2 {f}_{r} \sqrt{{ɛ}_{reff}} \sqrt{{μ}_{0} {ɛ}_{0}}} - 2 Δ L = \frac{{v}_{0}}{2 {f}_{r} \sqrt{{ɛ}_{reff}}} - 2 Δ L \qquad ( EQ 2 )$$

Where v0 is the speed of light in free space, εreff is the effective dielectric constant

$${E}_{reff} = \frac{{ɛ}_{r} + 1}{2} + {\frac{{ɛ}_{r} - 1}{2} [ 1 + 12 \frac{h}{w} ]}^{- 1 / 2} \qquad ( EQ 3 )$$

Where “h” is the substrate thickness

$$Δ L = 0.412 \frac{( {ɛ}_{reff} + 0.3 ) ( \frac{W}{h} + 0.246 )}{( {ɛ}_{reff} - 0.258 ) ( \frac{W}{h} + 0.8 )} h \qquad ( EQ 4 )$$

where ΔL is defined to be the patch length of the microstrip antenna that is larger than its physical size because of the fringing effect.

It has been discovered that the feed horn array 202 can be designed to support a specific frequency spectrum by adjusting the slot opening 310 positioned beneath the feed horn array 202. The dimensions of the slot opening 310 can provide an impedance matching to the waveguide opening 210 of FIG. 2 of the waveguide interposer 204 of FIG. 2. By matching the impedance of the waveguide opening 210, an antenna gain in the range of 30 dBi to 36.8 dBi can be achieved.

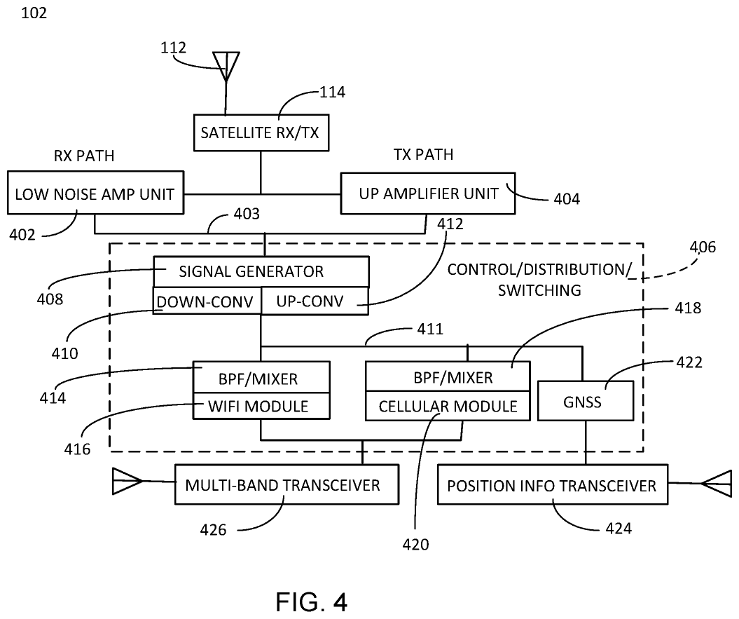

Referring now to FIG. 4, therein is shown a functional block diagram of the transportable base station 102 in an alternative embodiment of the present invention. The functional block diagram of the transportable base station 102 depicts the flat panel antenna 112 coupled to the satellite Rx/Tx 114. A low-noise Amplifier unit 402 can be in the receiver path in order to boost the received signal level. An up-amplifier unit 404 can boost the signal voltage in the transmission path to the satellite Rx/Tx 114. The low-noise amplifier unit 402 can be an analog circuit configured to raise the signal level without introducing electrical noise into a satellite frequency 403. The up-amplifier unit 404 can be an analog circuit configured to raise the voltage level of an encoded signal, at the satellite frequency 403, in preparation for sending the up-link satellite packet 122 of FIG. 1 to the satellite 104 of FIG. 1.

A control/distribution/switching module 406 can process the down-link satellite packets 121 of FIG. 1 and generate the frequency and data content for the up-link satellite packets 122. The control/distribution/switching module 406 can be an application specific integrated circuit (ASIC) that includes a signal generator 408 for generating and tracking the reference frequency for encoding/decoding the data sent to or received from the satellite 104.

A low-noise block downconverter 410 can serve as the RF front end of the satellite Rx/Tx 114, receiving the microwave signal from the satellite 104, amplifying it, and down-converting the block of frequencies to a lower block of intermediate frequencies (IF). The low-noise block downconverter 410 can be a hardware circuit tuned for reducing the frequencies received from the satellite 104 to a more easily routable internal frequency 411. It is understood that the internal frequency 411 can be a decades lower frequency than the satellite frequency 403.

In the transmission path, a block up-converter 412 can receive encoded messages at the internal frequency 411 and boost the frequency of the encoded messages to the satellite frequency 403. The block up-converter 412 can be a hardware circuit capable of combining the encoded messages at the internal frequency 411 with the reference frequency generated by the signal generator 408 to produce the encoded messages at the satellite frequency 403.

A band pass filter (BPF)/mixer 414 can condition messages that are processed by a WiFi module 416 that can support 802.11 b/g/n for providing Internet access. The BPF/mixer 414 and the WiFi module 416 are both hardware modules that work together to transfer the WiFi packets 130 of FIG. 1. An additional band pass filter (BPF)/mixer 418 can condition messages that are processed by a cellular module 420. The additional BPF/mixer 418 and the cellular module 420 are both hardware modules that work together to transfer the cellular communication packets 126 of FIG. 1. The cellular module 420 can support several communication standards including 3G, 4G, long term evolution (LTE), and 5G. It is understood that other communication standards can be implemented.

Both the WiFi module 416 and the cellular module 420 can be coupled to a multi-band transceiver 426 that can boost the power of the WiFi packets 130 and the cellular communication packets 126 for communication with external devices including the cellular applications 106 and the WiFi applications 108. The multi-band transceiver 426 can be a hardware module capable of transmitting and receiving messages at different frequencies and having different content. The multi-band transceiver 426 can provide sufficient power to broadcast the content from the WiFi module 416 and the cellular module 420. The multi-band transceiver 426 can produce wireless Internet signals 130 such as WiFi packets 130 having a frequency of 2.4 GHz.

A global navigation satellite system (GNSS) module 422 can be coupled to the internal frequency 411 to pass location, routing, and services information to a position information transceiver 424 for broadcast to the global positioning system application (GPS) 110 of FIG. 1. The GNSS module 422 can be a hardware structure that can communicate with the satellite 104 to provide routing services for global positioning systems including GPS, European Galileo, Beidou of China, or Glonass of Russia. The position information transceiver 424 can be a hardware structure used to broadcast and receive position information, routing, and services that can be exchanged with the global positioning system application (GPS) 110. The GNSS module 422 can support four position information reception and 400 channels.

It is understood that the transportable base station 102 can include the power module 116 of FIG. 1 in order to provide the energy required to power the hardware circuits for communicating between the satellite 104 and the cellular applications 106, the WiFi applications 108, and the global positioning system application (GPS) 110. It is further understood that additional interface modules can be installed in order to support specific communication structures not listed above.

It has been discovered that the transportable base station 102 can provide a number of communication services without the use of the local infrastructure 105 that may be damaged or without the power required to operate normally. The transportable base station 102 provides a communication base for exchanging information between the satellite 104, the cellular applications 106, the WiFi applications 108, and the global positioning system application (GPS) 110, that can support a few people, such as first responders, aid workers, emergency medical technicians, or a small town with hundreds of people. The transportable base station 102 can act as a temporary base for all emergency communication to provide a WiFi zone of at least 1 km. The transportable base station 102 can also provide a communication structure for a residence that is off-the-grid and has no wired power available.

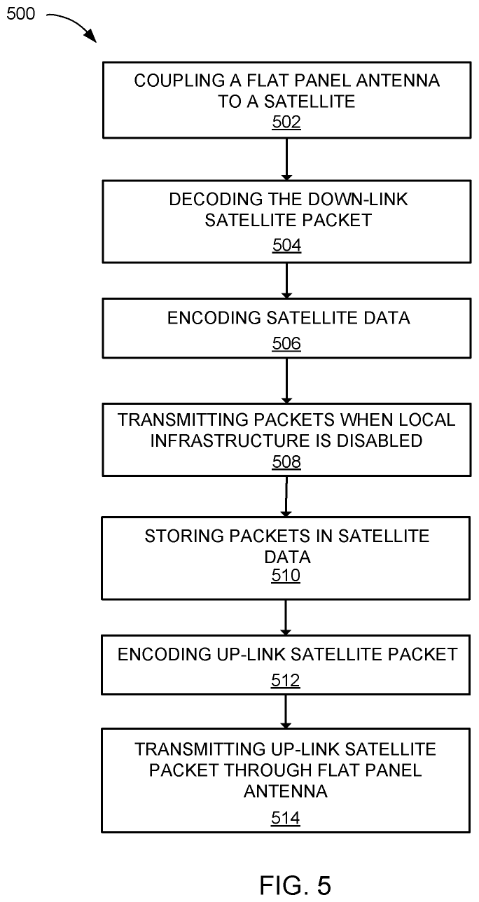

Referring now to FIG. 5, therein is shown a flow chart of a method 500 of operation of a multi-mode communication system 100 in an embodiment of the present invention. The method 500 includes: coupling a flat panel antenna to a satellite including receiving a down-link satellite packet in a block 502; decoding the down-link satellite packet including storing the satellite data in a block 504; encoding the satellite data to form cellular communication packets, WiFi packets, location and services packets, or a combination thereof in a block 506; transmitting the cellular communication packets, the WiFi packets, and the location and services packets, when the local infrastructure is disabled in a block 508; storing the cellular communication packets, WiFi packets, location and services packets in the satellite data in a block 510; encoding an up-link satellite packet from the satellite data in a block 512; and transmitting the up-link satellite packet through the flat panel antenna to the satellite in a block 514.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance.

These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A multi-mode communication system comprising:
a flat panel antenna configured to receive a down-link satellite packet;
a satellite Rx/Tx, coupled to the flat panel antenna, configured to decode the down-link satellite packet;
a storage device, coupled to the satellite Rx/Tx, configured to store satellite data from the down-link satellite packet;
an interface module, coupled to the storage device, configured to encode and transfer the satellite data as cellular communication packets, WiFi packets, location and services packets, or a combination thereof when a local infrastructure is disabled; and
wherein:
the interface module is further configured to receive the cellular communication packets, the WiFi packets, the location and services packets, or a combination thereof and store the content in the satellite data;
the satellite Rx/Tx is further configured to encode the satellite data as an up-link satellite packet; and
the flat panel antenna is further configured to transmit the up-link satellite packet to the satellite.

2. The system as claimed in claim 1 wherein the flat panel antenna includes:
a feed horn array including a slot opening;
a waveguide interposer, coupled to the feed horn array, including a waveguide opening; and
a waveguide interface, coupled to the waveguide interposer, opposite the feed horn array and
wherein:
the slot opening is aligned with the waveguide opening.

3. The system as claimed in claim 1 wherein the interface module configured to transfer the satellite data when a local infrastructure is disabled includes a power module powering the interface module.

4. The system as claimed in claim 1 wherein the flat panel antenna is configured to receive the down-link satellite packet includes receiving a frequency in the range of 27.5 GHz to 32.5 GHz when the satellite is in Low Earth Orbit (LEO).

5. The system as claimed in claim 1 wherein the flat panel antenna is configured to receive the down-link satellite packet includes receiving a frequency in the range of 10.7 GHz to 14.9 GHz when the satellite in in Geosynchronous Earth Orbit (GEO).

6. The system as claimed in claim 1 wherein the flat panel antenna configured to couple a satellite measures 12.5 cm by 2.1 cm for the satellite in LEO.

7. The system as claimed in 1 wherein the flat panel antenna configured to couple a satellite measures 30 cm by 30 cm for the satellite in GEO.

8. The system as claimed in 1 wherein the interface module configured to transfer the satellite data as cellular communication packets includes accepting 3G, 4G, long term evolution (LTE), 5G, or a combination thereof through the cellular communication packets.

9. The system as claimed in 1 further comprising a low-noise amplifier coupled to the satellite Rx/Tx to boost the amplitude of the down-link satellite packet.

10. The system as claimed in 1 further comprising a control/distribution/switching module, coupled to the satellite Rx/Tx, configured to:
receive a satellite frequency;
down-convert the satellite frequency to an internal frequency; and
generate the location and services packets by the internal frequency input to a global navigation satellite system (GNSS) module.

11. A method of operation of a multi-mode communication system comprising:
coupling a flat panel antenna to a satellite including receiving a down-link satellite packet;
decoding the down-link satellite packet including storing the satellite data;
encoding the satellite data to form cellular communication packets, WiFi packets, location and services packets, or a combination thereof;
transmitting the cellular communication packets, the WiFi packets, and the location and services packets, when the local infrastructure is disabled;
storing the cellular communication packets, WiFi packets, location and services packets in the satellite data;
encoding an up-link satellite packet from the satellite data; and
transmitting the up-link satellite packet through the flat panel antenna to the satellite.

12. The method as claimed in claim 11 wherein coupling the flat panel antenna including:
coupling a feed horn array, including a slot opening;
coupling a waveguide interposer, including a waveguide opening, to the feed horn array; and
coupling a waveguide interface to the waveguide interposer opposite the feed horn array; and
wherein:
aligning the slot opening to the waveguide opening.

13. The method as claimed in claim 11 further comprising powering the interface module by a power module for transferring the satellite data when the local infrastructure is disabled.

14. The method as claimed in claim 11 wherein receiving the down-link satellite packet includes receiving a frequency in the range of 27.5 GHz to 32.5 GHz when the satellite is in Low Earth Orbit (LEO).

15. The method as claimed in claim 11 wherein receiving the down-link satellite packet includes receiving a frequency in the range of 10.7 GHz to 14.9 GHz when the satellite in in Geosynchronous Earth Orbit (GEO)

16. The method as claimed in claim 11 wherein coupling a flat panel antenna to the satellite including the flat panel antenna measuring 12.5 cm by 2.1 cm for the satellite in LEO

17. The method as claimed in claim 11 wherein coupling a flat panel antenna to the satellite including the flat panel antenna measuring 30.0 cm by 30.0 cm for the satellite in GEO

18. The method as claimed in claim 11 wherein the interface module configured to transfer the satellite data as cellular communication packets includes accepting 3G, 4G, long term evolution (LTE), 5G, or a combination thereof through the cellular communication packets.

19. The method as claimed in claim 11 further comprising boosting an amplitude of the down-link satellite packet by a low-noise amplifier coupled to the satellite Rx/Tx.

20. The method as claimed in claim 11 further comprising:
receiving a satellite frequency;
down-converting the satellite frequency to an internal frequency; and
generating the location and services packets by inputting the internal frequency to a global navigation satellite system (GNSS) module.
